(19) United States
(12) Patent Application Publication
(10) Pub. No.: US 2025/0085137 A1
(43) Pub. Date: Mar. 13, 2025

(54) METHOD AND DEVICE FOR ESTIMATING REVOLUTIONS OF A BEARING ON AN OBJECT

(71) Applicant: Aktiebolaget SKF, Göteborg (SE)

(72) Inventors: Xiaoyuan MA, Shanghai (CN); Hongwei WU, Shanghai (CN); Xing YI, Shanghai (CN); Bingliang LOU, Shanghai (CN); Liang ZHANG, Zou Cheng (CN)

(21) Appl. No.: 18/826,512

(22) Filed: Sep. 6, 2024

(30) Foreign Application Priority Data
Sep. 13, 2023 (CN) 202311182291.6

(51) Int. Cl. G01C 22/00

(52) U.S. Cl. CPC G01C 22/00

(57) ABSTRACT

A method and associated device for estimating revolutions of a bearing on an object. The method includes receiving a plurality of measurement data from a sensor. Each of the plurality of measurement data has a corresponding time stamp. The plurality of measurement data is measured by the sensor waking up based on a first time interval. During running of the object, the first time interval changes based on a running status of the object. The method includes determining a total travelled distance of the object based on the plurality of measurement data and determining a travelled distance offset of the bearing. The travelled distance offset is a distance that the object has travelled when the bearing is installed on the object. The method includes determining the revolutions of the bearing based on the determined total travelled distance of the object and the determined travelled distance offset of the bearing.

### CROSS-REFERENCE TO RELATED APPLICATION

This application claims priority to Chinese Application No. 202311182291.6, filed Sep. 13, 2023, the entirety of which is hereby incorporated by reference.

### FIELD

Embodiments of the present disclosure relate to a technical field of data processing, and more specifically, to a method and a device for estimating revolutions of a bearing on an object.

### BACKGROUND

To comprehensively profile the usage of wheel bearings of an object (such as a train, a metro, a vehicle, etc.) or realize trustworthy remote diagnosis of the bearings, recording revolutions of the bearings (that is, the accumulated revolutions since the installation of the bearings) is a very key input. In order to measure such an accumulated metric, continuous monitoring is required generally. However, an energy-constrained (e.g., battery-powered) IoT sensor (e.g., vibration and temperature sensors) generally only wakes up and performs a measurement for few times per day, thereby saving energy consumption. This means that it is difficult for such an energy-constrained sensor to be always-on to record revolutions. Therefore, there is a need for an effective method in which energy-constrained sensors can be used to speculate or estimate the revolutions of a bearing on an object.

### SUMMARY

The SUMMARY section is provided to introduce concepts in a brief form, which will be described in detail in the DETAILED DESCRIPTION section below. The SUMMARY section is not intended to identify key features or essential features of the claimed technical solutions, nor is it intended to limit the scope of the claimed technical solutions.

Embodiments of the present disclosure provide a method for estimating revolutions of a bearing on an object, which includes: receiving a plurality of measurement data from a sensor, wherein each of the plurality of measurement data has a corresponding time stamp, wherein the plurality of measurement data is measured by the sensor waking up based on a first time interval, and wherein during running of the object, the first time interval changes based on a running status of the object; determining a total travelled distance of the object based on the plurality of measurement data; determining a travelled distance offset of the bearing, wherein the travelled distance offset of the bearing is a distance that the object has travelled when the bearing is installed on the object; and determining the revolutions of the bearing based on the determined total travelled distance of the object and the determined travelled distance offset of the bearing.

According to embodiments of the present disclosure, the first time interval changing based on a running status of the object comprises: decreasing the first time interval according to a first change factor in a case that the running status of the object is a first status; and increasing the first time interval according to a second change factor whose change rate is less than that of the first change factor in a case that the running status of the object is a second status.

According to embodiments of the present disclosure, the first change factor is a multiplication factor and the second change factor is an addition factor.

According to embodiments of the present disclosure, the running status of the object comprises one or more of the following: a fast-running status, a slow-running status and a stopping status, and wherein the first status is a fast-running status, and the second status is a slow-running status or a stopping status.

According to embodiments of the present disclosure, each of the plurality of measurement data includes location information of the object, the location information being used for indicating a location of the object when the measurement data is measured, and wherein the determining a total travelled distance of the object based on the plurality of measurement data includes: determining a first incremental travelled distance of the object based on the location information of the object and the corresponding time stamp; and adding the first incremental travelled distance with a previously travelled distance of the object to determine the total travelled distance.

According to embodiments of the present disclosure, the sensor includes a positioning module, and wherein the location information of the object is acquired via the positioning module.

According to embodiments of the present disclosure, each of the plurality of measurement data includes running status information of the object, the running status information being used for indicating a running status of the object when the measurement data is measured, and wherein the determining a total travelled distance of the object based on the plurality of measurement data includes: determining a running time of the object based on the running status information of the object and the corresponding time stamp; determining a second incremental travelled distance of the object based on the running time and a running speed corresponding to the running time; and adding the second incremental travelled distance with a previously travelled distance of the object to determine the total travelled distance.

According to embodiments of the present disclosure, the sensor includes a speed acquisition module, and wherein the running status information of the object is acquired via the speed acquisition module.

According to embodiments of the present disclosure, the determining the revolutions of the bearing based on the determined total travelled distance of the object and the determined travelled distance offset of the bearing includes: subtracting the travelled distance offset from the total travelled distance to obtain a first travelled distance of the bearing; and dividing the first travelled distance by a second travelled distance associated with the bearing to obtain the revolutions, wherein the second travelled distance is a distance travelled by the object when the bearing rotates a turn.

Embodiments of the present disclosure provide a device for estimating revolutions of a bearing on an object, which includes: a transceiver configured to receive a plurality of measurement data from a sensor, wherein each of the plurality of measurement data has a corresponding time stamp, wherein the plurality of measurement data is measured by the sensor waking up based on a first time interval, and wherein during running of the object, the first time interval changes based on a running status of the object; and a processor coupled to the transceiver and configured to determine a total travelled distance of the object based on the plurality of measurement data; determine a travelled distance offset of the bearing, wherein the travelled distance offset of the bearing is a distance that the object has travelled when the bearing is installed on the object; and determine the revolutions of the bearing based on the determined total travelled distance of the object and the determined travelled distance offset of the bearing.

Embodiments of the present disclosure provide an apparatus for estimating revolutions of a bearing on an object, which includes: a communication module configured to receive a plurality of measurement data from a sensor, wherein each of the plurality of measurement data has a corresponding time stamp, wherein the plurality of measurement data is measured by the sensor waking up based on a first time interval, and wherein during running of the object, the first time interval changes based on a running status of the object; a first determination module configured to determine a total travelled distance of the object based on the plurality of measurement data; a second determination module configured to determine a travelled distance offset of the bearing, wherein the travelled distance offset of the bearing is a distance that the object has travelled when the bearing is installed on the object; and a third determination module configured to determine the revolutions of the bearing based on the determined total travelled distance of the object and the determined travelled distance offset of the bearing.

Embodiments of the present disclosure provide a computer-readable storage medium having stored thereon instructions that, when executed, cause a processor to perform any method for estimating revolutions of a bearing on an object and/or any method for changing a wake-up time interval of a sensor based on a running status of the object according to embodiments of the present disclosure.

The method, device and apparatus provided by the present disclosure have at least one or more of the following advantages: 1) by exploiting one or few energy-constrained sensors (rather than relying on any wire-powered always-on devices), the revolutions of a wheel bearing can be speculated, and 2) by using the method provided by the present disclosure, the track of the object equipped with the one or few sensors also can be potentially profiled.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic, and the original and elements are not necessarily drawn to scale.

FIG. 1 shows a schematic diagram of determining a travelled distance of an object based on location information received from a sensor according to embodiments of the present disclosure;

FIG. 2 shows a schematic diagram of revising a distance by exploiting a GIS method according to embodiments of the present disclosure;

FIG. 3 shows a schematic diagram of determining a travelled distance of an object based on running status information received from a sensor according to embodiments of the present disclosure;

FIG. 4 shows an example flow of a method for estimating revolutions of a bearing on an object performed on a computing device according to embodiments of the present disclosure;

FIG. 5 shows a schematic scene diagram of changing a wake-up time interval of a sensor based on a running status of an object according to embodiments of the present disclosure;

FIG. 6 shows an example flow of changing a wake-up time interval of a sensor based on a running status of an object according to embodiments of the present disclosure;

FIG. 7 shows a schematic diagram of performing measurement using a plurality of sensors according to embodiments of the present disclosure;

FIG. 8 shows a schematic diagram of a method for estimating revolutions of a bearing on an object according to embodiments of the present disclosure;

FIG. 9 shows a schematic diagram of a device for estimating revolutions of a bearing on an object according to embodiments of the present disclosure; and

FIG. 10 shows a schematic diagram of an apparatus for estimating revolutions of a bearing on an object according to embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method implementations of the present disclosure may be performed in a different order and/or in parallel. Furthermore, method implementations may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of some other terms will be given in the following description.

It should be noted that the concepts of “first” and “second” mentioned in the present disclosure are only used to distinguish different means, modules or units, and are not used to limit the order or interdependence of the functions performed by these means, modules or units.

It should be noted that the modifications of “a” and “a plurality” mentioned in the present disclosure are schematic but not limiting, and those skilled in the art should understand that unless the context clearly indicates otherwise, they should be understood as “one or more”.

Names of messages or information exchanged among multiple apparatuses in the implementations of the present disclosure are only used for illustrative purposes, and are not used to limit the scope of these messages or information.

In the present disclosure, an object may refer to any object that travels through wheels and is equipped with wheel bearings, such as a train, a metro, a vehicle (a car, a truck, etc.), a bicycle, etc.

In the present disclosure, an energy-constrained sensor may refer to a sensor that wakes up and performs measurement only once or a few times in a certain time period in order to save energy consumption, for example, a battery-powered sensor.

In order to realize trustworthy remote diagnosis of bearings by sensors (for example, vibration and temperature sensors), as one of the most commonly used inputs, accumulated revolutions since the installation of the bearings is expected to be provided. In order to measure such an accumulated metric, continuous monitoring is required generally, which is a great challenge for energy-constrained (e.g., battery-powered) Internet of Things (IoT) sensors to be always-on.

The present disclosure provides a method for speculating revolutions of a wheel bearing by using one or (few) several energy-constrained sensors installed in an object. The method may be realized by using a computing device and one or several energy-constrained sensors. The sensor wakes up to measure measurement data of the object (for example, location or running status, etc.) and record corresponding time stamps, and upload the measurement data to the computing device (for example, a server, a cloud server or a gateway, etc.). The next wake-up time (or wake-up time interval) of the sensor may be determined by a scheduling mechanism based on the running status of the object (for example, speed, acceleration or other equivalent metrics). Then, the computing device may speculate a distance travelled by the object equipped with the sensor. Based on this, revolutions of wheel bearings can be further estimated or speculated. When there are several sensors, these sensors can be scheduled in turn (for example, wake up in turn and one after another, or wake up in different periods, etc.) to further save energy consumption.

In some embodiments, a sensor installed in an object (e.g., a train or metro, etc.) can provide location information (for example, it may further include a moving direction, a speed, etc.) of the object and/or sense the running status of the object (e.g., fast-running, slow-running or stopping, etc.). Generally, the location information of the object may be obtained via a positioning module (for example, a Global Position System (GPS)/Global Navigation Satellite System (GNSS) module, etc.), and the running status of the object may be sensed via a speed acquisition module. In some embodiments, the speed acquisition module may be an accelerometer module, a gyroscope, and any other existing or future module that can be applied to sense the speed of an object. In some embodiments, the speed acquisition module may also be a receiving module capable of receiving external information input (for example, speed information of the object, etc.) from the outside or other modules. In order to simplify the description, an accelerometer module will be described below as an example.

In some embodiments, the location information and/or running status of the object may be obtained through one or more sensors (for example, temperature sensors or vibration sensors) already equipped on the object currently. For example, an existing (or associated) positioning module and/or accelerometer module in one or more sensors already equipped on the object currently can be used to obtain the location information and/or running status of the object, or a positioning module and/or accelerometer module may be integrated in one or more sensors already equipped on the object currently to obtain the location information and/or running status of the object. In addition, the location information and/or running status of the object can also be obtained through one or more specific sensors including a positioning module and/or an accelerometer module. In some cases, these sensors may be energy-constrained sensors.

Hereinafter, an exemplary description will be made taking a scene of one sensor as an example. For example, in order to save energy, the sensor may wake up periodically or at a specific time interval Δt to measure the measurement data of the object (for example, location or running status, etc.) and record the corresponding time stamps, and upload the measurement data to the computing device (for example, a server, a cloud server or a gateway, etc.). In some embodiments, the measurement data may be uploaded at a pre-configured time point. In some embodiments, measurement data may be uploaded based on a request or trigger of the computing device. In some embodiments, the measurement data may be uploaded together with other data (e.g., temperature data, vibration data, etc.).

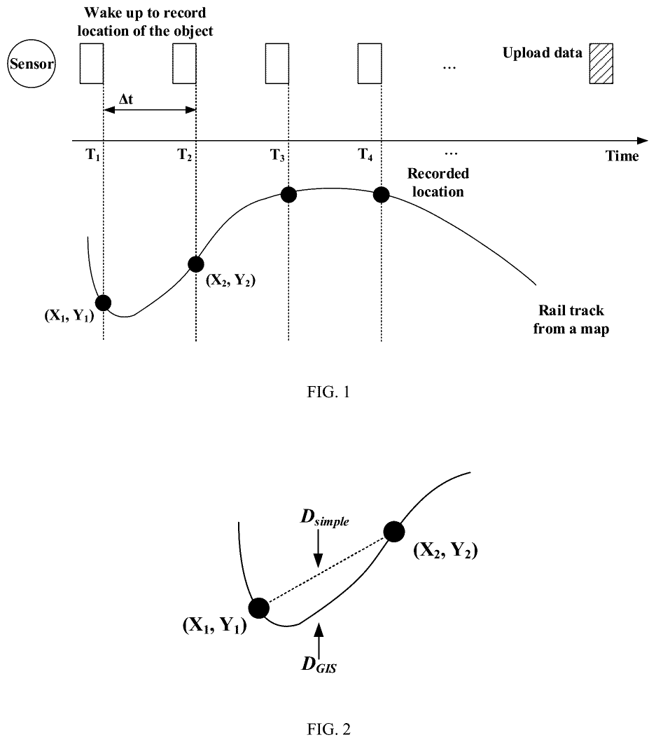

FIG. 1 shows a schematic diagram of determining a travelled distance of an object based on location information received from a sensor according to embodiments of the present disclosure. For an application (for example, a train application) where location information can be easily available, as shown in FIG. 1, location information (for example, object locations recorded at times T₁, T₂, T₃, . . . , T₄, etc.) recorded by the sensor may be plotted in a computing device (e.g., a cloud server, etc.). The distance between two location samples (for example, the distance between location samples at T₁ and T₂) may be simply estimated by \sqrt{(X₁−X₂)²+(Y₁−Y₂)²}, where X and Y (i.e., X₁, Y₁, X₂, Y₂) represent location coordinates of the object (e.g., latitude and longitude). To simplify the issue, a more specific process of conversion of latitude and longitude location coordinates to the distance is omitted here. If more accuracy is expected, a time interval (or may be referred to as a wake-up periodicity) Δt between adjacent sample time points (for example, the time interval between T₁ and T₂) can be shortened or the distance can be revised by exploiting a Geographic Information System (GIS) method. In some embodiments, the time interval Δt may be a preset constant. In some embodiments, the time interval Δt may have an initial value which is a preset constant, and may change based on the running status of the object (for example, further based on the running speed, etc.) during the running of the object.

FIG. 2 shows a schematic diagram of revising a distance by exploiting a GIS method according to embodiments of the present disclosure. As shown in FIG. 2, a rail line corresponding to two adjacent location samples can be selected on a specific map and the length distance of the two adjacent location samples on the rail line can be calculated. The distance simply estimated based on the above equation may be expressed as Dₛᵢₘₚₗₑ=\sqrt{(X₁−X₂)₂+(Y₁−Y₂)²}, while the distance further revised based on the GIS method as shown in FIG. 2 may be expressed as D_{GIS}(X₁, Y₁, X₂, Y₂). Furthermore, based on the distance between every two adjacent location samples, by the addition thereof, the distance travelled by the object in any time period or between any two location samples can be calculated.

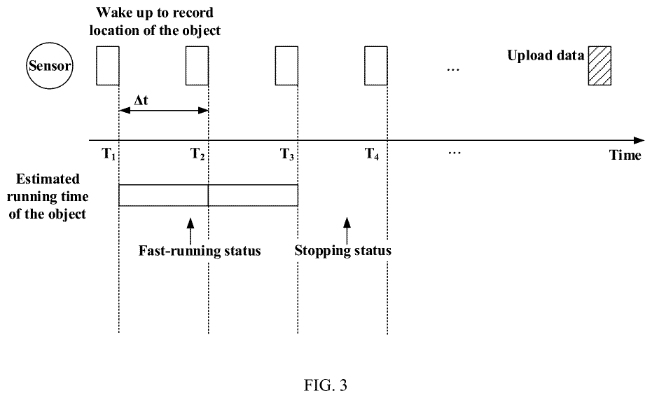

FIG. 3 shows a schematic diagram of determining a travelled distance of an object based on running status information received from a sensor according to embodiments of the present disclosure.

For an application (for example, a metro application) where location information cannot be easily available but an average speed can be easily available, as shown in FIG. 3, a running status of an object (for example, a metro) can be measured or recorded. In some embodiments, the running status of the object may include one or more of the following: a fast-running status, a slow-running status or a stopping status. In this way, a running time of the object can be estimated in a computing device based on the running status information of the object and the corresponding time stamps, and the distance travelled by the object can be estimated by multiplying the running time by corresponding average speeds. In some embodiments, a corresponding average speed may be estimated or configured in advance for each running status of the object. For example, a fast-running status may correspond to a first speed, a slow-running status may correspond to a second speed lower than the first speed, and a stopping status may correspond to a zero speed. In other embodiments, the average speed of the object in different running statuses may be obtained or estimated by any other way, which is not limited herein. FIG. 3 shows only two running statuses, namely, a fast-running status and a stopping status. It may be assumed in the present disclosure that the running status of the object will not change within a time interval Δt. Therefore, in the example of FIG. 3, it can be considered that the object is in a fast-running status during the period from T₁ to T₃, and in a stopping status during the period from T₃ to T₄.

In addition, the location information and/or running status of the object recorded by the sensors may be sent or uploaded to the computing device immediately after they are recorded, or may be uploaded uniformly at a preset time as shown by the shaded rectangle in FIG. 1 or FIG. 3. There is no limitation on the specific data uploading time or manner herein.

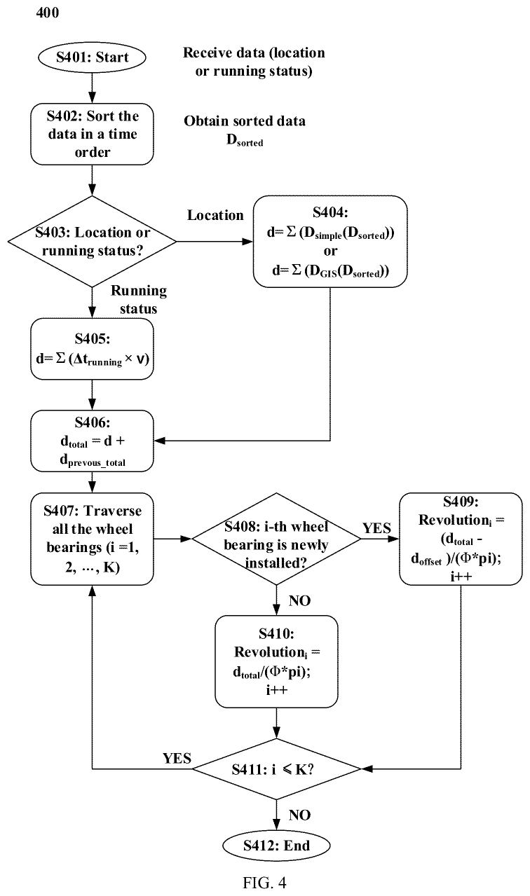

FIG. 4 shows an example flow of a method 400 for estimating revolutions of a bearing on an object performed on a computing device according to embodiments of the present disclosure.

As shown in FIG. 4, the method 400 may start at step S401, in which a computing device (e.g., a server, a cloud server, etc.) may receive data including location information or running status information of an object from a sensor.

In step S402, the received data may be sorted in a time order (for example, according to the time stamps corresponding to the measurement data) to obtain sorted data D_{sorted}.

In step S403, it may be determined which information (e.g., location information and/or running status information) is included in the data. If location information is included in the data (for example, in a train application), the method 400 may proceed to step S404. In step S404, a first incremental travelled distance of the object may be calculated in combination with the methods described in FIG. 1 and/or FIG. 2 above. For example, as shown in FIG. 1, the computing device may calculate the distance (for example, segment distance corresponding to each time interval Δt) between two adjacent location samples sorted in a time order through the manners described above, and then accumulate the segment distances corresponding to all time intervals Δt to obtain the first incremental travelled distance travelled by the object in the time period corresponding to these location information.

If running status information is included in the data (for example, in a metro application), the method 400 may proceed to step S405. In step S405, a second incremental travelled distance of the object may be calculated in combination with the method described in FIG. 3. For example, as shown in FIG. 3, as mentioned above, it is assumed that the running status of the object will not change within a time interval Δt, so the running time of the object in each running status can be easily determined based on the plurality of running status information and corresponding time stamps. By multiplying the running time of the object in each running status with a predetermined average speed corresponding to the each running status, the second incremental travelled distance travelled by the object in the time period corresponding to these running status information can be determined.

Then, in step S406, the first incremental travelled distance d determined in step S404 or the second incremental travelled distance d determined in step S405 may be added to the total distance d_{prevous_total} that the object has previously travelled, thereby obtaining the total travelled distance dₜₒₜₐₗ of the object.

Next, in step S407, for an application where there are K wheel bearings (for example, K is an integer greater than or equal to 1), all the wheel bearings may be traversed with operations of steps S408-S411 being performed.

For example, in step S408, it may be determined whether an i-th wheel bearing among the K wheel bearings is newly installed. If the bearing is newly installed, in step S409, a travelled distance offset d_{offset} of the bearing may be subtracted from the total travelled distance dₜₒₜₐₗ of the object, and then the result is divided by the circumference Φ*pi of the wheel corresponding to the bearing (where Φ represents the diameter of the wheel), so as to determine the revolutions of the bearing, Revolutionᵢ. As described above, the travelled distance offset d_{offset} of the bearing may be the distance that the object has already travelled when the bearing is installed on the object. If the bearing is not newly installed, for example, it was installed before the object started to travel, the method 400 may proceed to step S410. In step S410, the revolutions of the bearing, Revolutionᵢ, may be determined directly by dividing the total travelled distance dₜₒₜₐₗ of the object by the circumference Φ*pi of the wheel corresponding to the bearing.

In step S411, it may be determined whether all the wheel bearings are traversed based on the number i of the current wheel bearing. If not all the wheel bearings have been traversed yet, the method may return to step S407 and steps S408-S411 may be performed again. If all the wheel bearings have been traversed, the method 400 may end in step S412.

It should be understood that the flowchart shown in FIG. 4 is only an example of a method for estimating revolutions of a bearing on an object according to embodiments of the present disclosure, and the steps in FIG. 4 may be performed in any other order. Furthermore, one or more steps in FIG. 4 may be omitted or combined with each other, or any other method or step according to embodiments of the present disclosure may be added thereto.

In some embodiments, in order to improve the estimation accuracy and further save energy consumption, a plurality of measurement data may be measured by a sensor waking up based on a wake-up time interval ΔT (herein, it can be called a first time interval), and during the running of an object, the wake-up time interval ΔT may change based on a running status of the object (for example, further based on a running speed, etc.). For example, when the object is running fast (i.e., in a fast-running status), the sensor may wake up more frequently to perform measurements, for example, the wake-up time interval ΔT of the sensor may be decreased multiplicatively (e.g., by a multiplication factor). When the object is running slowly (i.e., in a slow-running status) or is still, the sensor may wake up less frequently to perform measurement, for example, the wake-up time interval of the sensor may be increased additively (e.g., by an addition factor).

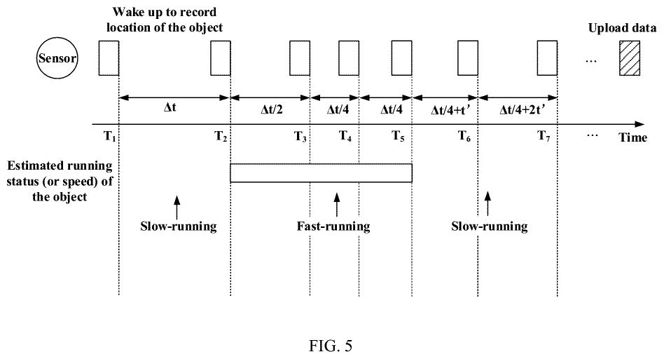

More specifically, FIG. 5 shows a schematic scene diagram of changing a wake-up time interval of a sensor based on a running status of an object according to embodiments of the present disclosure.

As shown in FIG. 5, it is assumed that an initial status of the object (for example, the running status at T₁) is a slow-running status. In this case, an initial value Δt corresponding to the slow-running status may be set for the wake-up time interval ΔT of the sensor. That is, the next wake-up time of the sensor is T₂, and the initial time interval between T₂ and T₁ is Δt.

When it is detected that the object is in a fast-running status at time T₂, a multiplicative decreasing operation may be performed on the current time interval Δt to obtain an updated/changed wake-up time interval. For example, the current time interval Δt may be multiplied by a multiplication factor, such as ½, so as to obtain an updated wake-up time interval ΔT=Δt/2. In this case, the next wake-up time may be T₃=T₂+Δt/2, but not T₂+Δt at a fixed time interval. Similarly, if it is continuously detected that the object is in a fast-running status at time T₃, the next wake-up time may be T₄=T₃+Δt/4. In some embodiments, when the object is detected to be in a fast-running status, the multiplicative decreasing operation may be always performed, until a preset minimum wake-up time interval is reached, for example, the wake-up time interval Δt/4 between T₃ and T₄ and between T₄ and T₅ as shown in FIG. 5.

Continuing back to FIG. 5, when it is detected that the object is in a slow-running status at time T₅, an additive increasing operation may be performed on the current time interval Δt/4 to obtain an updated/changed wake-up time interval. For example, the current time interval Δt/4 may be added with an addition factor, such as t′ (for example, 60 seconds, etc.), so as to obtain an updated wake-up time interval ΔT=Δt/4+t′. In this case, the next wake-up time may be T₆=T₅+Δt/4+t′. Similarly, if it is continuously detected that the object is in a slow-running status at time T₆, the next wake-up time may be T₇=T₆+Δt/4+2t′. In some embodiments, when the object is detected to be in a slow-running status, the additive increasing operation may be always performed, until a preset maximum wake-up time interval is reached.

It should be understood that the multiplication factor ½, the addition factor t′, the minimum wake-up time interval and the maximum wake-up time interval described here are just examples, and they can have any other suitable values depending on the actual application. In addition, FIG. 5 shows only two running statuses, namely, a fast-running status and a slow-running status. It should be understood that in order to improve the estimation accuracy, the running status of the object may also include one or more other running statuses, such as a still status or a stopping status, a first-speed running status, a second-speed running status, a third-speed running status, a fourth-speed running status and the like, and each running status may have a corresponding addition factor or multiplication factor, and the addition factors or multiplication factors corresponding to different running statuses may be the same or different.

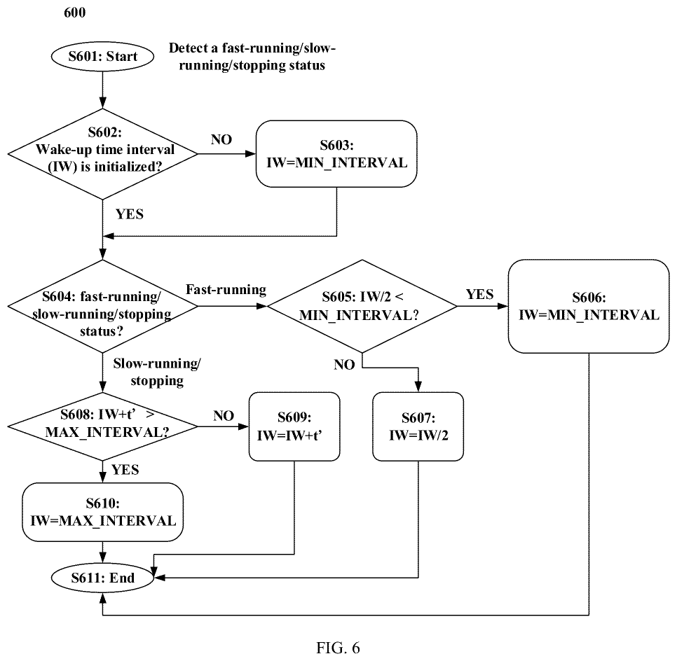

FIG. 6 shows an example flow 600 of changing a wake-up time interval of a sensor based on a running status of an object according to embodiments of the present disclosure.

As shown in FIG. 6, the example flow 600 may start at step S601. In step S601, a running status of an object (for example, a fast-running status, a slow-running status or a stopping status) may be detected. In this example, in order to simplify the description, the fast-running status may be taken as a first status, and the slow-running status or stopping status may be taken as a second status.

In step S602, it may be determined whether a wake-up time interval IW is initialized. If not, the flow 600 may proceed to step S603 to initialize the IW. For example, the IW may be initialized to a minimum wake-up time interval MIN_INTERVAL. In other embodiments, the IW may also be initialized to a maximum wake-up time interval MAX_INTERVAL, or any other suitable initial value IW_INITIAL, which is not limited here. If the IW has been initialized, the flow 600 proceeds to step S604.

In step S604, it may be determined whether the current or recently detected running status of the object is a first status (i.e., a fast-running status) or a second status (i.e., a slow-running status or a stopping status). If it is the first status, as described above, it is expected that the sensor can wake up more frequently, so the flow 600 can proceed to step S605 to decrease the wake-up time interval. Assuming that the multiplication factor corresponding to the first status is ½, it may first be judged in step S605 whether the product IW/2 of the current wake-up time interval IW and the multiplication factor ½ is less than the minimum wake-up time interval MIN_INTERVAL. If the product IW/2 of the current wake-up time interval IW and the multiplication factor ½ has been less than the minimum wake-up time interval MIN_INTERVAL, that is, the minimum wake-up time interval MIN_INTERVAL has been reached, IW may be set as the minimum wake-up time interval MIN_INTERVAL in step S606. If the product IW/2 of the current wake-up time interval IW and the multiplication factor ½ is not less than the minimum wake-up time interval MIN_INTERVAL, IW may be set as the product IW/2 of the current wake-up time interval IW and the multiplication factor ½ in step S607.

In step S604, if it is determined that the running status of the object is the second status, it is expected that the sensor can wake up less frequently at this time, so the flow 600 may proceed to step S608 to increase the wake-up time interval. Assuming that the addition factor corresponding to the second status is t′, it may first be judged in step S608 whether the sum IW+t′ of the current wake-up time interval IW and the addition factor of t′ is greater than the maximum wake-up time interval MAX_INTERVAL. If the sum IW+t′ of the current wake-up time interval IW and the addition factor of t′ is already greater than the maximum wake-up time interval MAX_INTERVAL, that is, the maximum wake-up time interval MAX_INTERVAL has been reached, IW may be set as the maximum wake-up time interval MAX_INTERVAL in step S610. If the sum IW+t′ of the current wake-up time interval IW and the addition factor of t′ is not greater than the maximum wake-up time interval MAX_INTERVAL, IW may be set as the sum IW+t′ of the current wake-up time interval IW and the addition factor of t′ in step S609.

The updated or changed current wake-up time interval IW can be determined through steps S606, S607, S609 or S610, after which the flow 600 may end at step S611.

In some embodiments, the example flow or method for changing the wake-up time interval of a sensor based on the running status of an object described herein may be performed at a computing device, or may be performed on the sensor, for example, by a scheduler running on the sensor. Furthermore, the flowchart shown in FIG. 6 is only an example of the method for changing the wake-up time interval of a sensor based on the running status of an object according to embodiments of the present disclosure, and the steps in FIG. 6 may be performed in any other order. Furthermore, one or more steps in FIG. 6 may be omitted or combined with each other, or any other method or step according to embodiments of the present disclosure may be added thereto.

When a plurality of sensors are installed on an object and can be used to perform the method for estimating revolutions of a bearing on the object and/or the method for changing an wake-up time interval of a sensor based on the running status of the object according to embodiments of the present disclosure, these sensors can further save energy by working in a time-division manner.

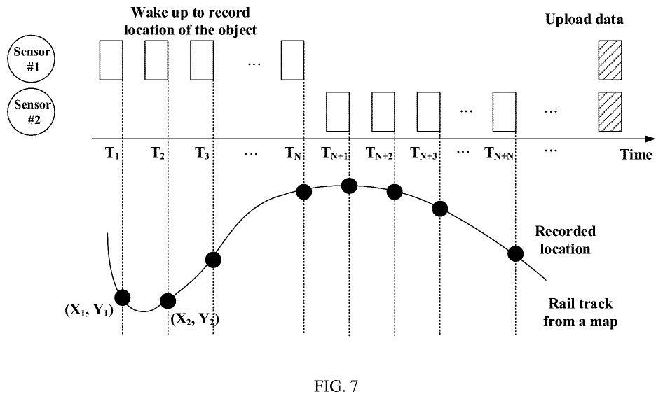

FIG. 7 shows a schematic diagram of performing measurement using a plurality of sensors according to embodiments of the present disclosure. Two sensors, i.e., sensor #1 and sensor #2, are exemplarily shown in FIG. 7. Sensor #1 and sensor #2 do not need to wake up at the same time to measure the location and/or running status of the object, but can work in a time-division manner. For example, sensor #1 can wake up and perform measurement according to the above-mentioned methods during a period from T₁ to T_{N}, during which sensor #2 does not need to work; while the sensor #2 can wake up and perform measurement according to the above-mentioned methods during a period from T_{N+1} to T_{X+N} after T_{N}, during which sensor #1 does not need to work. Thereafter, the two sensors can work alternately according to the set working time periods thereof in this way, thus further saving energy consumption.

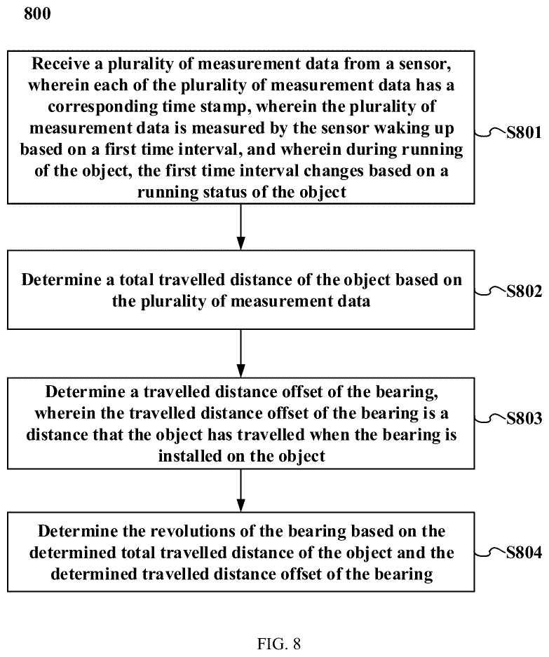

Next, FIG. 8 shows a schematic diagram of a method 800 for estimating revolutions of a bearing on an object according to embodiments of the present disclosure.

As shown in FIG. 8, the method 800 for estimating revolutions of a bearing on an object according to embodiments of the present disclosure may include: in step S801, receiving a plurality of measurement data from a sensor; in step S802, determining a total travelled distance of the object based on the plurality of measurement data; in step S803, determining a travelled distance offset of the bearing, where the travelled distance offset of the bearing is a distance that the object has travelled when the bearing is installed on the object; and in step S804, determining the revolutions of the bearing based on the determined total travelled distance of the object and the determined travelled distance offset of the bearing. In some embodiments, each of the plurality of measurement data may have a corresponding time stamp. In some embodiments, as described above, the plurality of measurement data may be measured by the sensor waking up based on a first time interval, and during running of the object, the first time interval may change based on a running status of the object (for example, further based on a running speed of the object, etc.).

In some embodiments, in a case that the running status of the object is a first status, the first time interval may be decreased according to a first change factor. In a case that the running status of the object is a second status, the first time interval may be increased according to a second change factor whose change rate is less than that of the first change factor. For example, in some embodiments, as described above, the first change factor may be a multiplication factor and the second change factor may be an addition factor. Generally, the change rate of an addition factor is less than the change rate of a multiplication factor. In some embodiments, the first change factor may also be an addition factor with a larger absolute value, such as −60s, while the second change factor may be an addition factor with a smaller absolute value, such as 30s, so that a faster-speed decreasing and a slower-speed increasing of the first time interval can still be achieved. Similarly, the first change factor and the second change factor may also be realized by multiplication factors with different numerical values, for example, the first change factor may be a multiplication factor 1/10 and the second change factor may be a multiplication factor 5.

In some embodiments, the running status of the object may include one or more of the following: a fast-running status, a slow-running status and a stopping status.

In some embodiments, the fast-running status may be regarded as the first status described above, and the slow-running status and/or the stopping status may be regarded as the second status described above.

In some embodiments, each of the plurality of measurement data may include location information of an object, which may be used to indicate the location of the object when the measurement data is measured. In some embodiments, the determining a total travelled distance of the object based on the plurality of measurement data in step S802 may further include: determining a first incremental travelled distance of the object based on the location information of the object and the corresponding time stamp; and adding the first incremental travelled distance with a previously travelled distance of the object to determine the total travelled distance.

For example, as shown in FIG. 1, a computing device may receive a plurality of measurement data including location information of an object from sensors and sort the plurality of location information according to corresponding time stamps. The computing device may calculate the distance (for example, segment distance corresponding to each time interval Δt) between two adjacent location samples sorted in a time order through the manners described above, and then accumulate the segment distances corresponding to all time intervals Δt to obtain the first incremental travelled distance travelled by the object in the time period corresponding to these location information. Then, the total travelled distance of the object can be obtained by adding the first incremental travelled distance to the total distance that the object has previously travelled.

In some embodiments, each of the plurality of measurement data may include running status information of the object, which may be used to indicate a running status of the object when the measurement data is measured. In some embodiments, the determining a total travelled distance of the object based on the plurality of measurement data in step S802 may further include: determining a running time of the object based on the running status information of the object and the corresponding time stamp; determining a second incremental travelled distance of the object based on the running time and a running speed corresponding to the running time; and adding the second incremental travelled distance with a previously travelled distance of the object to determine the total travelled distance.

For example, as shown in FIG. 3, a computing device may receive a plurality of measurement data including running status information of the object from the sensors, and sort the plurality of running status information according to corresponding time stamps. As mentioned above, it is assumed that the running status of the object will not change within a time interval Δt, so the running time of the object in each running status can be easily determined based on the plurality of running status information and corresponding time stamps. By multiplying the running time of the object in each running status with a predetermined average speed corresponding to the each running status, the second incremental travelled distance travelled by the object in the time period corresponding to these running status information can be determined. Then, the total travelled distance of the object can be obtained by adding the second incremental travelled distance to the total distance that the object has previously travelled.

In some embodiments, the determining the revolutions of the bearing based on the determined total travelled distance of the object and the determined travelled distance offset of the bearing in step S804 may further include: subtracting the travelled distance offset from the total travelled distance to obtain a first travelled distance of the bearing; and dividing the first travelled distance by a second travelled distance associated with the bearing to obtain the revolutions, where the second travelled distance may be a distance travelled by the object when the bearing rotates a turn. For example, the second travelled distance may be the circumference of a wheel corresponding to the bearing. Furthermore, as described above, the travelled distance offset of the bearing may be the distance that the object has already travelled when the bearing is installed on the object.

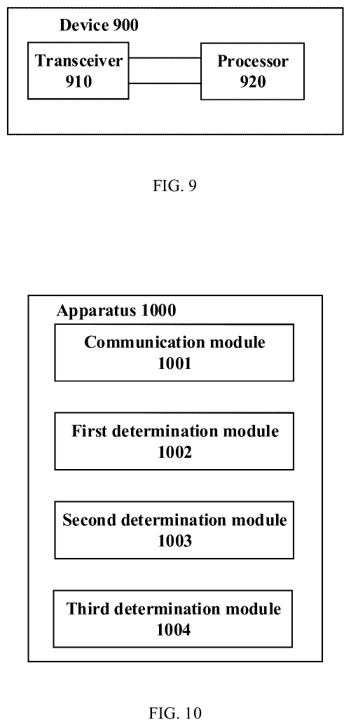

FIG. 9 shows a schematic diagram of a device 900 for estimating revolutions of a bearing on an object according to embodiments of the present disclosure.

The device 900 may be any computing device capable of performing data processing, such as a local server, a cloud server, a data processing center, etc. As shown in FIG. 9, the device 900 may include a transceiver 910 and a processor 920. The transceiver 910 may be configured to receive a plurality of measurement data from a sensor. In some embodiments, each of the plurality of measurement data may have a corresponding time stamp. In some embodiments, as described above, the plurality of measurement data may be measured by the sensor waking up based on a first time interval, and during running of the object, the first time interval may change based on a running status of the object (for example, further based on a running speed of the object, etc.). The processor 920 may be communicatively coupled to the transceiver 910, and may be configured to determine a total travelled distance of the object based on the plurality of measurement data; determine a travelled distance offset of the bearing, where the travelled distance offset of the bearing is a distance that the object has travelled when the bearing is installed on the object; and determine the revolutions of the bearing based on the determined total travelled distance of the object and the determined travelled distance offset of the bearing.

In addition, the device 900 can also perform any other method or step according to the embodiments of the present disclosure as described above, which will not be repeated in detail here.

FIG. 10 shows a schematic diagram of an apparatus 1000 for estimating revolutions of a bearing on an object according to embodiments of the present disclosure.

As shown in FIG. 10, the apparatus 1000 may include a communication module 1001, a first determination module 1002, a second determination module 1003 and a third determination module 1004. The communication module 1001 may be configured to receive a plurality of measurement data from a sensor. In some embodiments, each of the plurality of measurement data may have a corresponding time stamp. In some embodiments, as described above, the plurality of measurement data may be measured by the sensor waking up based on a first time interval, and during running of the object, the first time interval may change based on a running status of the object (for example, further based on a running speed of the object, etc.). The first determination module 1002 may be configured to determine a total travelled distance of the object based on the plurality of measurement data. The second determination module 1003 may be configured to determine a travelled distance offset of the bearing, where the travelled distance offset of the bearing is a distance that the object has travelled when the bearing is installed on the object. The third determination module 1004 may be configured to determine the revolutions of the bearing based on the determined total travelled distance of the object and the determined travelled distance offset of the bearing.

In addition, the apparatus 1000 may also include other modules that perform any other methods or steps according to the embodiments of the present disclosure as described above, which are not repeated in detail here.

Particularly, according to the embodiments of the present disclosure, the methods or processes described above in connection with the embodiments of the present disclosure or the drawings may be implemented as a computer software program. For example, an embodiment of the present disclosure includes a computer program product including computer programs carried on a non-transitory computer-readable medium, which includes program codes for executing the methods shown in the flowcharts. In such an embodiment, the computer programs may be downloaded and installed from the network through a communication device, or installed from a storage device, or installed from a ROM. When the computer programs are executed by a processing device, the above functions defined in the methods of the embodiments of the present disclosure are performed.

Furthermore, embodiments of the present disclosure provide a computer-readable storage medium having stored thereon instructions that, when executed, cause a processor to perform any method for estimating revolutions of a bearing on an object and/or any method for changing a wake-up time interval of a sensor based on a running status of the object according to embodiments of the present disclosure.

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions shown in the blocks may occur in a different order other than those shown in the drawings. For example, two blocks shown in succession may actually be executed substantially in parallel, and they may sometimes be executed in a reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or may be implemented by a combination of dedicated hardware and computer instructions.

The units involved in the embodiments described in the present disclosure may be implemented by software or hardware. Herein, the names of the units do not mean a limitation to the units themselves in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store programs for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The above description is only preferred embodiments of the present disclosure and the explanation of the applied technical principles. It should be understood by those skilled in the art that the disclosure scope involved in the present disclosure is not limited to the technical schemes formed by the specific combination of the above technical features, but also encompasses other technical schemes formed by any combination of the above technical features or their equivalent features without departing from the above disclosure concept, for example, technical schemes formed by replacing the above features with technical features (but not limited thereto) with similar functions disclosed in the present disclosure.

Furthermore, although the operations are depicted in a particular order, this should not be understood as requiring these operations to be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are only exemplary forms for implementation of the claims.

What is claimed is:

1. A method for estimating revolutions of a bearing on an object, the method comprising:
receiving a plurality of measurement data from a sensor, wherein each of the plurality of measurement data has a corresponding time stamp, wherein the plurality of measurement data is measured by the sensor waking up based on a first time interval, and wherein during running of the object, the first time interval changes based on a running status of the object;
determining a total travelled distance of the object based on the plurality of measurement data;
determining a travelled distance offset of the bearing, wherein the travelled distance offset of the bearing is a distance that the object has travelled when the bearing is installed on the object; and
determining the revolutions of the bearing based on the determined total travelled distance of the object and the determined travelled distance offset of the bearing.

2. The method according to claim 1, wherein the first time interval changing based on a running status of the object comprises:
decreasing the first time interval according to a first change factor in a case that the running status of the object is a first status; and
increasing the first time interval according to a second change factor whose change rate is less than that of the first change factor in a case that the running status of the object is a second status.

3. The method according to claim 2, wherein the first change factor is a multiplication factor and the second change factor is an addition factor.

4. The method according to claim 2, wherein the running status of the object comprises one or more of the following: a fast-running status, a slow-running status and a stopping status, and
wherein the first status is a fast-running status, and the second status is a slow-running status or a stopping status.

5. The method according to claim 1, wherein each of the plurality of measurement data comprises location information of the object, the location information being used for indicating a location of the object when the measurement data is measured, and
wherein the determining a total travelled distance of the object based on the plurality of measurement data comprises:
determining a first incremental travelled distance of the object based on the location information of the object and the corresponding time stamp; and
adding the first incremental travelled distance with a previously travelled distance of the object to determine the total travelled distance.

6. The method according to claim 5, wherein the sensor comprises a positioning module, and wherein the location information of the object is acquired via the positioning module.

7. The method according to claim 1, wherein each of the plurality of measurement data comprises running status information of the object, the running status information being used for indicating a running status of the object when the measurement data is measured, and
wherein the determining a total travelled distance of the object based on the plurality of measurement data comprises:
determining a running time of the object based on the running status information of the object and the corresponding time stamp;
determining a second incremental travelled distance of the object based on the running time and a running speed corresponding to the running time; and
adding the second incremental travelled distance with a previously travelled distance of the object to determine the total travelled distance.

8. The method according to claim 7, wherein the sensor comprises a speed acquisition module, and wherein the running status information of the object is acquired via the speed acquisition module.

9. The method according to claim 1, wherein the determining the revolutions of the bearing based on the determined total travelled distance of the object and the determined travelled distance offset of the bearing comprises:
subtracting the travelled distance offset from the total travelled distance to obtain a first travelled distance of the bearing; and
dividing the first travelled distance by a second travelled distance associated with the bearing to obtain the revolutions,
wherein the second travelled distance is a distance travelled by the object when the bearing rotates a turn.

10. A device for estimating revolutions of a bearing on an object, the device comprising:
a transceiver configured to:
receive a plurality of measurement data from a sensor, wherein each of the plurality of measurement data has a corresponding time stamp, wherein the plurality of measurement data is measured by the sensor waking up based on a first time interval, and wherein during running of the object, the first time interval changes based on a running status of the object; and
a processor coupled to the transceiver and configured to:
determine a total travelled distance of the object based on the plurality of measurement data;
determine a travelled distance offset of the bearing, wherein the travelled distance offset of the bearing is a distance that the object has travelled when the bearing is installed on the object; and
determine the revolutions of the bearing based on the determined total travelled distance of the object and the determined travelled distance offset of the bearing.
